(19) United States
(12) Patent Application Publication
(10) Pub. No.: US 2012/0121282 A1
(43) Pub. Date: May 17, 2012

(54) IMAGE FORMATION DEVICE AND IMAGE FORMATION METHOD

(75) Inventors: Masashi OBA, Shiojiri (JP); Akihiro GOMI, Fujimi-machi (JP)

(73) Assignee: SEIKO EPSON CORPORATION, Tokyo (JP)

(21) Appl. No.: 13/289,637

(22) Filed: Nov. 4, 2011

(30) Foreign Application Priority Data
Nov. 12, 2010 (JP) 2010-253869

(51) Int. Cl. G03G 15/10

(52) U.S. Cl. 399/57

(57) ABSTRACT

An image formation device comprises a control portion for controlling the amount of liquid developer supplied from a toner supply portion and the amount of carrier solution supplied from a carrier solution supply portion to adjust the toner concentration of liquid developer of a liquid developer concentration adjustment portion and to control the amount of liquid developer of the liquid developer concentration adjustment portion on the basis of the measured toner concentration of the liquid developer and the amount of the liquid developer, wherein the control portion adjusts the toner concentration of the liquid developer in the liquid developer concentration adjustment portion and controls the amount of the liquid developer in the liquid developer concentration adjustment portion when a recovered liquid stagnation detection portion does not detect that a recovered liquid is stagnant.

### CROSS-REFERENCE TO RELATED APPLICATIONS

This application claims priority to Japanese Patent Application No. 2010-253869 filed on Nov. 12, 2010. The entire disclosure of Japanese Patent Application No. 2010-253869 is hereby incorporated herein by reference.

### BACKGROUND

1. Technical Field

The present invention relates to an electrographic image formation device and an image formation method in which a liquid developer containing a toner and a carrier solution is used to develop a latent image formed on a photoreceptor as a latent image carrier and form an image.

2. Background Technology

Many image formation devices are in well-known practice in which a liquid developer containing a toner and a carrier solution is used to develop a latent image formed on a photoreceptor as a latent image carrier and form an image. Image formation devices which reuse recovered liquid developer not used in the developing have been proposed as this type of image formation device (for example, see Patent Citation 1). In this image formation device disclosed in Patent Citation 1, liquid developer is supplied from a concentration adjustment tank to a liquid developer storage portion of a developing portion, liquid developer that overflowed from the liquid developer storage portion and liquid developer remaining after developing, i.e. liquid developer that was not used in the developing is returned as recovered liquid to the concentration adjustment tank, and this recovered liquid is reused as liquid developer. In this case, to stabilize image quality and enable continuous printing, the concentration of the liquid developer in the concentration adjustment tank is adjusted and the amount of liquid is controlled.

There is also a known image formation device in which a concentration sensor and a liquid amount sensor are set up in the concentration adjustment tank in order to adjust the concentration and control the amount of liquid developer in the concentration adjustment tank (for example, see Patent Citation 2). In this image formation device disclosed in Patent Citation 2, the amounts of toner and carrier solution supplied to the concentration adjustment tank are controlled according to the outputs of the concentration sensor and the liquid amount sensor.

Japanese Patent Application Publication Nos. 2009-075552 (Patent Citation 1) and 2009-075558 (Patent Citation 2) are examples of the related art.

### SUMMARY

### Problems to be Solved by the Invention

However, in the image formation devices disclosed in Patent Citations 1 and 2, since the liquid developer is highly viscous, when a continuous printing action is performed, there are instances in which recovered liquid does not smoothly flow continuously within a recovered liquid discharge tube which is a recovery route of recovered liquid flowing from the developing portion to the concentration adjustment tank, and the recovered liquid temporarily stagnates. Particularly in cases in which continuous printing of print data having a low streak rate is performed, stagnation occurs readily because the concentration of the recovered liquid increases.

When such stagnation occurs and the recovered liquid does not flow continuously to the concentration adjustment tank, the concentration and amount of the liquid developer in the concentration adjustment tank change significantly. In view of this, the aforementioned concentration adjustment and liquid amount control are performed in the concentration adjustment tank, and new toner and carrier solution are supplied to the concentration adjustment tank. When the amount of stagnant recovered liquid in the concentration adjustment tank increases in this state, the stagnant recovered liquid falls within the concentration adjustment tank due to its own weight. The stagnation of the recovered liquid is thereby resolved. However, since the recovered liquid that has stagnated flows into the concentration adjustment tank in a short amount of time, the liquid level within the concentration adjustment tank rises, and there is a possibility of the liquid developer in the concentration adjustment tank overflowing or of the concentration of the liquid developer becoming unadjustable.

The invention was devised in view of such circumstances, and an advantage thereof is to provide an image formation device and an image formation method whereby the liquid developer can be prevented from overflowing and the liquid developer can be prevented from becoming unadjustable in concentration even when the recovered liquid has become stagnant.

### Means Used to Solve the Above-Mentioned Problems

To achieve the advantage previously described, in the image formation device and image formation method according to the invention, the concentration of liquid developer including a toner and a carrier solution is adjusted to a first toner concentration and the amount of liquid developer is adjusted in a liquid developer concentration adjustment portion. During a printing action, the liquid developer in the liquid developer concentration adjustment portion is supplied to a liquid developer storage portion of a developing portion where a certain amount is stored, and the liquid developer flows out from the liquid developer storage portion. Using the liquid developer stored in this liquid developer storage portion, a developer carrier of a developing portion develops a latent image formed on a latent image carrier, and an image is formed on the latent image carrier. After the developing, the liquid developer remaining on the developer carrier is removed. Recovered liquid, which includes the recovered liquid developer that has flowed out from the liquid developer storage portion and liquid developer removed from the developer carrier, is stored in a recovered liquid storage portion. The recovered liquid stored in the recovered liquid storage portion moves through a recovery route to be stored in the liquid developer concentration adjustment portion. At this time, stagnation of the recovered liquid occurring in the recovery route is detected by a recovered liquid stagnation detection portion. The detection of recovered liquid stagnation is performed in the following manner. Specifically, the flow rate of recovered liquid flowing through the recovery route is calculated based on the amount of liquid developer in the liquid developer concentration adjustment portion as measured by a liquid amount measurement portion, and recovered liquid stagnation occurring in the recovery route is detected using the calculated recovered liquid flow rate. When the recovered liquid stagnation detection portion does not detect stagnation of the recovered liquid, the concentration of liquid developer stored in the liquid developer concentration adjustment portion is adjusted to a first toner concentration and the amount of liquid developer of the liquid developer concentration adjustment portion is controlled. When the recovered liquid stagnation detection portion does detect stagnation of the recovered liquid, concentration adjustment of the liquid developer stored in the liquid developer concentration adjustment portion is stopped and liquid amount control of the liquid developer in the liquid developer concentration adjustment portion is stopped.

Thus, when the recovery route has stagnated in the recovery route, concentration adjustment of the liquid developer in the liquid developer concentration adjustment portion and liquid amount control of the liquid developer in the liquid developer concentration adjustment portion are not performed. Therefore, new carrier solution and new toner of a second toner concentration higher than the aforementioned first toner concentration are not supplied to the liquid developer concentration adjustment portion even when the concentration and amount of the liquid developer in the liquid developer concentration adjustment portion change significantly due to stagnation of the recovered liquid. Thereby, the liquid level of the liquid developer stored in the liquid developer concentration adjustment portion does not rise. In this state, when the recovered liquid that has stagnated in the recovery route falls to the liquid developer concentration adjustment portion due to its own weight and the recovered liquid stagnation is resolved, the recovered liquid that had been stagnant flows into the liquid developer concentration adjustment portion in a short amount of time, and the liquid level within the liquid developer concentration adjustment portion therefore rises. However, since the liquid level within the liquid developer concentration adjustment portion does not rise due to new toner or new carrier solution not being supplied, the liquid level within the liquid developer concentration adjustment portion does not rise significantly even when the liquid level within the liquid developer concentration adjustment portion is thus raised by the recovered liquid. Therefore, the liquid developer in the liquid developer concentration adjustment portion can be prevented from overflowing. It is thereby possible for the amount of liquid developer in the liquid developer concentration adjustment portion to be maintained within a predetermined range. It is also possible to easily and reliably adjust the liquid developer concentration because overflowing of the liquid developer is prevented.

Therefore, even if highly viscous liquid developer is used, a continuous printing action can be performed while the concentration of liquid developer in the liquid developer concentration adjustment portion is maintained at a first toner concentration and the amount of liquid developer in the liquid developer concentration adjustment portion is maintained within a predetermined range. Continuous printing with high image quality can thereby be stably performed without interrupting the continuous printing action.

Particularly, a special flow rate sensor or the like for measuring the recovered liquid flow rate need not be used, simply because the liquid amount measurement portion, which has been used in concentration/liquid-amount control systems, is used. Thereby, there is little need to change the design of a well-known concentration/liquid-amount control system, and stagnation of the recovered liquid occurring in the recovery route can be detected more reliably with a simple configuration.

### BRIEF DESCRIPTION OF THE DRAWINGS

Referring now to the attached drawings which form a part of this original disclosure:

FIG. 1 is a drawing which schematically and partially depicts part of an example of an embodiment of the image formation device used in the image formation method according to the invention;

FIG. 2 is a partial enlarged drawing schematically depicting a photoreceptor, a developing portion, a photoreceptor squeeze portion, a developer recovering and replenishing portion, and a concentration/liquid-amount control system of the example shown in FIG. 1;

FIG. 3 is a block diagram of the concentration/liquid-amount control system;

FIG. 4 is a graph describing a change in the flow rate of the recovered liquid due to stagnation of the recovered liquid;

FIG. 5 is a graph describing another change in the flow rate of the recovered liquid due to stagnation of the recovered liquid; and

FIG. 6 is a chart showing the flow of concentration adjustment and liquid amount control by the concentration/liquid-amount control system.

### DETAILED DESCRIPTION OF EXEMPLARY EMBODIMENTS

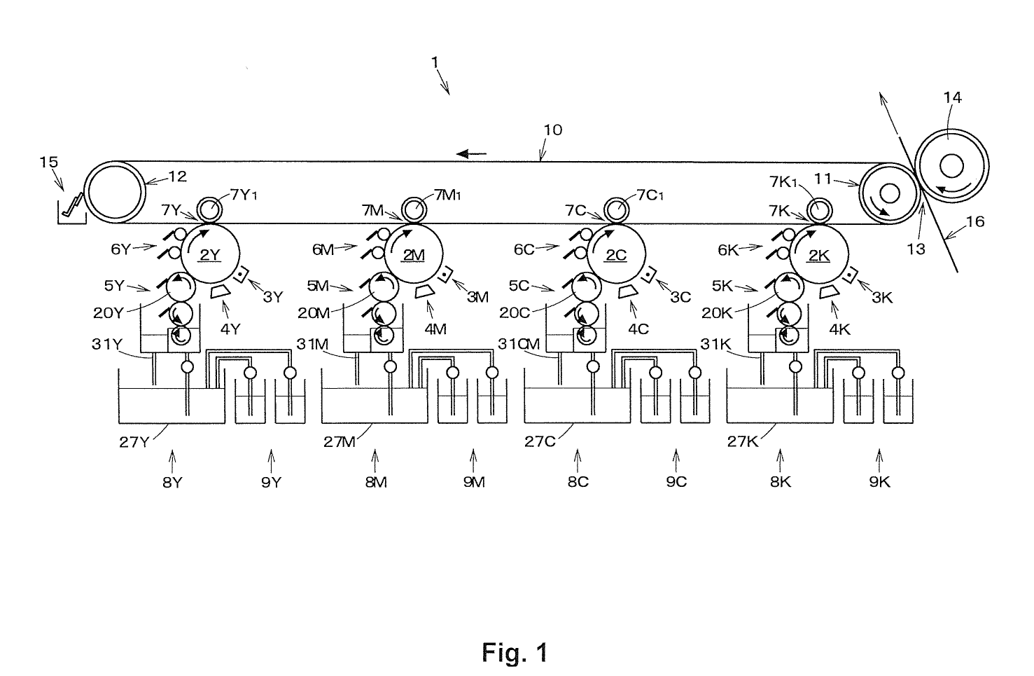

Modes for carrying out the invention are described hereinbelow with reference to the accompanying drawings. FIG. 1 is a drawing which schematically and partially depicts part of an example of an embodiment of the image formation device used in the image formation method according to the invention.

The image formation device 1 of this example includes photoreceptors 2Y, 2M, 2C, 2K which are latent image carriers of the colors yellow (Y), magenta (M), cyan (C), and black (K), and which are disposed in tandem either horizontally or substantially horizontally, as shown in FIG. 1. Electrostatic latent images of the corresponding colors Y, M, C, K are formed and carried on the respective photoreceptors 2Y, 2M, 2C, 2K. Each of the photoreceptors 2Y, 2M, 2C, 2K is driven by drive portions (not shown) and made to rotate in the arrow directions in FIG. 1 (clockwise in FIG. 1). Among the photoreceptors 2Y, 2M, 2C, 2K; 2Y represents a yellow photoreceptor, 2M a magenta photoreceptor, 2C a cyan photoreceptor, and 2K a black photoreceptor. The letters of each color Y, M, C, and K are added to the symbols of other members to represent members of each color so that the same applies to the other members.

Electrifying portions 3Y, 3M, 3C, 3K are set up in the peripheries of the photoreceptors 2Y, 2M, 2C, 2K, respectively. Furthermore, the following members are respectively set up in order in the rotational directions of the photoreceptors 2Y, 2M, 2C, 2K from the electrifying portions 3Y, 3M, 3C, 3K: exposure portions 4Y, 4M, 4C, 4K; developing portions 5Y, 5M, 5C, 5K; photoreceptor squeeze portions 6Y, 6M, 6C, 6K; and primary transfer portions 7Y, 7M, 7C, 7K. Though not shown in the drawing, diselectrifying portions for diselectrifying the photoreceptors 2Y, 2M, 2C, 2K after the primary transfer and photoreceptor cleaning portions for cleaning the photoreceptors 2Y, 2M, 2C, 2K are respectively set up in order in the rotational directions of the photoreceptors 2Y, 2M, 2C, 2K from the primary transfer portions 7Y, 7M, 7C, 7K.

Furthermore, developer recovering and replenishing portions 8Y, 8M, 8C, 8K and concentration/liquid-amount control systems 9Y, 9M, 9C, 9K are set up corresponding to the respective developing portions 5Y, 5M, 5C, 5K. The concentration/liquid-amount control systems 9Y, 9M, 9C, 9K are partially disclosed in FIG. 1.

Furthermore, the image formation device 1 includes an endless intermediate transfer belt 10. This intermediate transfer belt 10 is disposed above the photoreceptors 2Y, 2M, 2C, 2K. In the primary transfer portions 7Y, 7M, 7C, 7K, the intermediate transfer belt 10 is pressed by primary transfer rollers 7Y1, 7M1, 7C1, 7K1 against the photoreceptors 2Y, 2M, 2C, 2K, respectively, in a manner that allows the belt to separate from and come in contact with the photoreceptors.

Though not shown in the drawing, the intermediate transfer belt 10 is formed as a comparatively soft elastic belt with a three-layer structure, having a flexible substrate made of a resin or the like, an elastic layer made of rubber or the like and formed on the surface of the substrate, and a surface layer formed on the surface of the elastic layer, for example. As shall be apparent, the belt is not limited to this example. The intermediate transfer belt 10 is wound over an intermediate transfer belt drive roller 11 to which the drive force of a motor (not shown) is transmitted, and an intermediate transfer belt tension roller 12. The intermediate transfer belt 10 is designed so as to rotate in the direction of the arrow (counterclockwise in FIG. 1) while under tension. The order in which the photoreceptors and other members corresponding to the colors Y, M, C, K are disposed is not limited to the example shown in FIG. 1, and this order can be set as desired.

A secondary transfer portion 13 is provided in the side of the intermediate transfer belt 10 that has the intermediate transfer belt drive roller 11. The secondary transfer portion 13 has a secondary transfer roller 14. The secondary transfer roller 14 rotates in the direction of the arrow (clockwise in FIG. 1). This secondary transfer roller 14 is pressed against the intermediate transfer belt 10 wound over the intermediate transfer belt drive roller 11, forming a secondary transfer nip. An intermediate transfer belt cleaning portion 15 is provided in the side of the intermediate transfer belt 10 that has the intermediate transfer belt tension roller 12.

Image formation units of each color of the image formation device 1 of this example are configured respectively by the photoreceptors 2Y, 2M, 2C, 2K, the electrifying portions 3Y, 3M, 3C, 3K, the exposure portions 4Y, 4M, 4C, 4K, the developing portions 5Y, 5M, 5C, 5K, the photoreceptor squeeze portions 6Y, 6M, 6C, 6K, the primary transfer portions 7Y, 7M, 7C, 7K, the photoreceptor cleaning portions, and the diselectrifying portions.

In the image formation device 1 of this example configured as such, the toner images of each color formed in the image formation units are transferred to the intermediate transfer belt 10 in the primary transfer portions 7Y, 7M, 7C, 7K, similar to well-known practice. At this time in the image formation device 1 of this example, the toner images of the colors Y, M, C, K are transferred in this order in overlapping colors to the intermediate transfer belt 10, and a full color toner image is formed on the intermediate transfer belt 10. Furthermore, in the nip of the secondary transfer portion 13, the toner image transferred to the intermediate transfer belt 10 is transferred to transfer paper or another transfer member 16 pressed against the intermediate transfer belt 10 by the secondary transfer roller 14. The toner image transferred to the transfer member is then fixed by a fixing portion (not shown), and an image is thereby formed on the transfer member 16.

Next, the developing portions 5Y, 5M, 5C, 5K, the photoreceptor squeeze portions 6Y, 6M, 6C, 6K, the developer recovering and replenishing portions 8Y, 8M, 8C, 8K, and the concentration/liquid-amount control systems 9Y, 9M, 9C, 9K of this example will be described in greater detail.

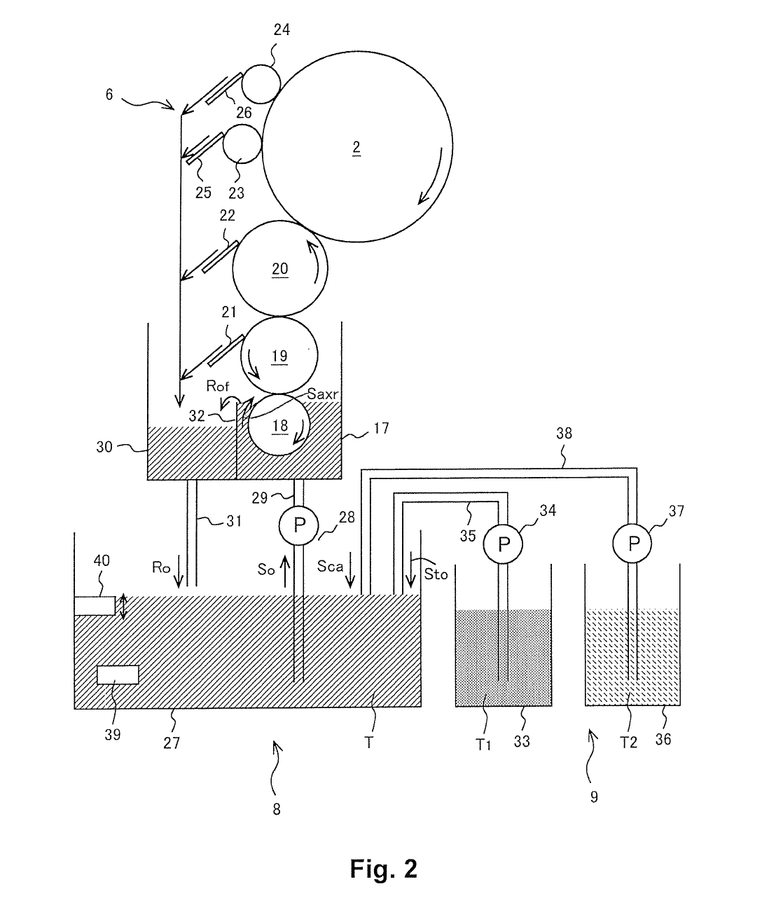

FIG. 2 is a partial enlarged drawing schematically depicting a photoreceptor, a developing portion, a photoreceptor squeeze portion, a developer recovering and replenishing portion, and a concentration/liquid-amount control system of the example shown in FIG. 1. The developing portions 5Y, 5M, 5C, 5K, the photoreceptor squeeze portions 6Y, 6M, 6C, 6K, the developer recovering and replenishing portions 8Y, 8M, 8C, 8K, and the concentration/liquid-amount control systems 9Y, 9M, 9C, 9K have the same configurations for each of the colors Y, M, C, K. FIG. 2 omits the color symbols Y, M, C, and K because the description is common for all colors. However, FIG. 1 adds the color letters Y, M, C, K to the symbols in correspondence with some of the structural elements shown in FIG. 2.

The developing portion 5 has a liquid developer storage portion 17, an anilox roller 18, an intermediate roller 19 which is a liquid developer supply member, a developing roller 20 which is a developer carrier, an intermediate roller cleaning blade 21 which is a liquid developer supply member cleaning member, and a developing roller cleaning blade 22 which is a liquid developer carrier cleaning member, as shown in FIG. 2. Part of the anilox roller 18 is submerged in the liquid developer T stored in the liquid developer storage portion 17, and the anilox roller 18 draws the liquid developer T up by rotating clockwise in FIG. 2. The intermediate roller 19 supplies a predetermined amount of the liquid developer T from the anilox roller 18 by rotating counterclockwise in FIG. 2. The developing roller 20 rotates counterclockwise in FIG. 2, whereby the liquid developer T is supplied from the intermediate roller 19 and carried, the electrostatic latent image on the photoreceptor 2 is developed by the toner in the carried liquid developer T, and a toner image is formed on the photoreceptor 2. The intermediate roller cleaning blade 21 cleans the intermediate roller 19 after the roller passes through the nip with the developing roller 20, and excess liquid developer T (mainly carrier solution) remaining on the intermediate roller 19 is removed. The developing roller cleaning blade 22 cleans the developing roller 20 after the electrostatic latent image of the photoreceptor 2 has been developed, and excess liquid developer T (mainly carrier solution) remaining on the developing roller 20 is removed.

The photoreceptor squeeze portion 6 has a first photoreceptor squeeze roller 23 (equivalent to a squeeze member of the invention), a second photoreceptor squeeze roller 24 (equivalent to the squeeze member of the invention), a first squeeze roller cleaning blade 25, and a second squeeze roller cleaning blade 26. The first and second photoreceptor squeeze rollers 23, 24 remove a predetermined amount of carrier solution on the photoreceptor 2 by rotating counterclockwise in FIG. 2 and squeezing the photoreceptor 2 after the developing by the developing portion 5. The first squeeze roller cleaning blade 25 cleans the first photoreceptor squeeze roller 23 after it has squeezed the photoreceptor 2, and removes carrier solution on the first photoreceptor squeeze roller 23. The second squeeze roller cleaning blade 26 cleans the second photoreceptor squeeze roller 24 after it has squeezed the photoreceptor 2, and removes carrier solution on the second photoreceptor squeeze roller 24.

The developer recovering and replenishing portion 8 has a concentration adjustment tank 27 which is a liquid developer concentration adjustment portion, a liquid developer supply pump (P) 28 (equivalent to the liquid developer supply member of the invention), a liquid developer supply tube 29, a recovered liquid storage portion 30, and a recovered liquid discharge tube 31. The concentration adjustment tank 27 is a tank for mixing concentrated toner T1 having a second toner concentration and carrier solution T2 to create liquid developer T, and adjusting the concentration of this liquid developer T to a predetermined first concentration (25 wt %, for example). The liquid developer supply pump 28 feeds the liquid developer T of a predetermined concentration in the concentration adjustment tank 27 through the liquid developer supply tube 29 to the liquid developer storage portion 17 of the developing portion 5.

The recovered liquid storage portion 30 is configured as a single container with the liquid developer storage portion 17. In this case, the liquid developer storage portion 17 and the recovered liquid storage portion 30 are divided by a dividing plate 32 (equivalent to the dividing portion of the invention). Though not shown, a notch (equivalent to the flow portion of the invention) is provided in the top edge of the dividing plate 32. When the top surface (the liquid surface) of the liquid developer T in the liquid developer storage portion 17 rises above the lowest position of the notch of the dividing plate 32, the liquid developer T in the liquid developer storage portion 17 passes through (overcomes) the notch of the dividing plate 32 and overflows out (flows out) to the recovered liquid storage portion 30. In this case, during the printing action, at least the amount of liquid developer T needed for developing is fed by the liquid developer supply pump 28 to the liquid developer storage portion 17, and is made to pass from the liquid developer storage portion 17 through the notch of the dividing plate 32 and overflow out to the recovered liquid storage portion 30. Due to the liquid developer T constantly overflowing out of the liquid developer storage portion 17 to the recovered liquid storage portion 30 in this manner, the amount of liquid developer T in the liquid developer storage portion 17 is always kept constant, and the liquid developer T is stably supplied to the anilox roller 18.

The recovered liquid storage portion 30 recovers liquid developer T (mainly carrier solution) removed from the intermediate roller 19 by the intermediate roller cleaning blade 21, liquid developer T (mainly carrier solution) removed from the developing roller 20 by the developing roller cleaning blade 22, and carrier solution removed from the first and second photoreceptor squeeze rollers 23, 24 respectively by the first and second squeeze roller cleaning blades 25, 26. The liquid developer T recovered in the recovered liquid storage portion 30 moves through the recovered liquid discharge tube 31 to be discharged into the concentration adjustment tank 27. Therefore, the recovered liquid discharge tube 31 constitutes a recovery route.

The concentration/liquid-amount control system 9 has a concentrated toner supply tank 33, a concentrated toner supply pump (P) 34 (equivalent to the toner supply portion of the invention), a concentrated toner supply tube 35, a carrier solution supply tank 36, a carrier solution supply pump (P) 37 (equivalent to the carrier solution supply portion of the invention), a carrier solution supply tube 38, a concentration sensor 39 (equivalent to the concentration measurement portion of the invention), and a liquid amount sensor 40 (equivalent to the liquid amount measurement portion of the invention).

The concentrated toner supply tank 33 stores concentrated toner T1 supplied to the concentration adjustment tank 27, the toner having a second toner concentration which is a higher toner concentration than the previously described first toner concentration. The concentrated toner supply pump 34 feeds the concentrated toner T1 in the concentrated toner supply tank 33 through the concentrated toner supply tube 35 to the concentration adjustment tank 27. The carrier solution supply tank 36 stores the carrier solution T2 supplied to the concentration adjustment tank 27. The carrier solution supply pump 37 feeds the carrier solution T2 in the carrier solution supply tank 36 through the carrier solution supply tube 38 to the concentration adjustment tank 27.

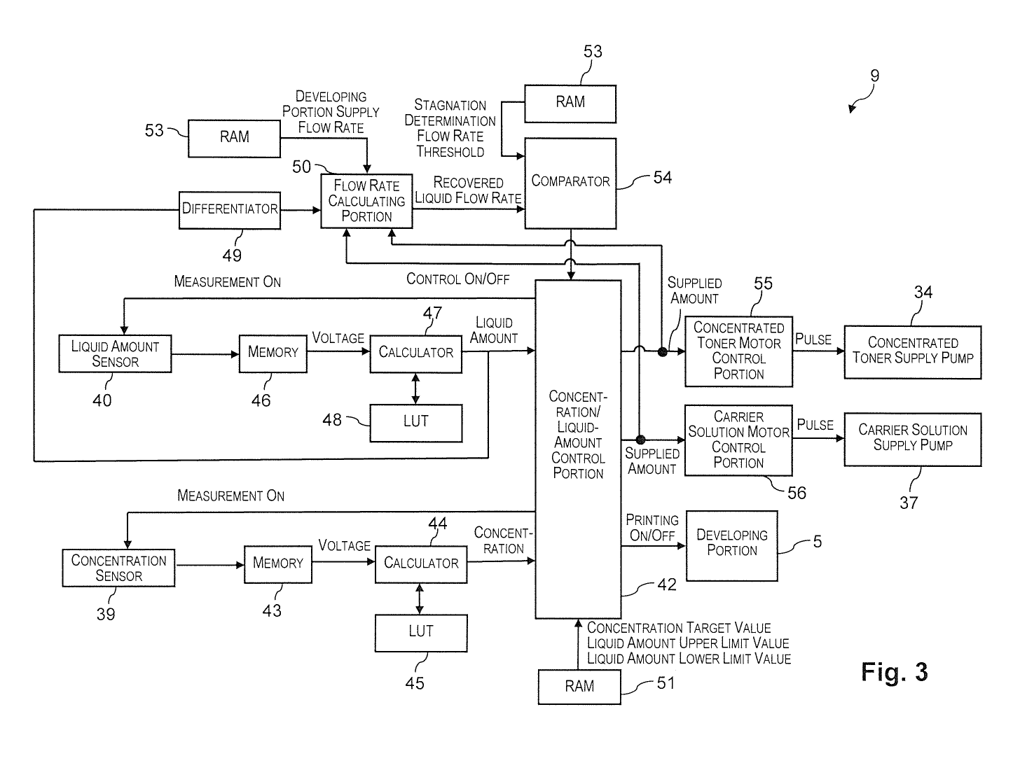

The concentration/liquid-amount control system 9 also has a concentration/liquid-amount control portion 42, a first memory 43, a first calculator 44, a first lookup table (LUT) 45, a second memory 46, a second calculator 47, a second lookup table (LUT) 48, a differentiator 49, a flow rate calculating portion 50, a first random access memory (RAM) 51, a second random access memory (RAM) 52, a third random access memory (RAM) 53, a comparator 54, a concentrated toner motor control portion 55, and a carrier solution motor control portion 56, as shown in FIG. 3.

The concentration/liquid-amount control portion 42 outputs a concentration measurement signal to the concentration sensor 39 when the concentration of the liquid developer T in the concentration adjustment tank 27 is to be measured. The measured concentration measurement signal is thereupon outputted as voltage from the concentration sensor 39. The voltage of the concentration measurement signal is stored in the first memory 43. The first calculator 44 converts the voltage stored in the first memory 43 to a concentration on the basis of the first LUT 45 which shows the relationship between voltage and concentration, and outputs this concentration to the concentration/liquid-amount control portion 42.

The concentration/liquid-amount control portion 42 outputs a liquid amount measurement signal to the liquid amount sensor 40 when the amount of liquid developer T in the concentration adjustment tank 27 is to be measured. The measured liquid amount measurement signal is thereupon outputted as voltage from the liquid amount sensor 40. The voltage of the liquid amount measurement signal is stored in the second memory 46. The second calculator 47 converts the voltage stored in the second memory 46 to a liquid amount on the basis of the second LUT 48 which shows the relationship between voltage and concentration, and outputs this liquid amount to the concentration/liquid-amount control portion 42.

Furthermore, a concentration target value of the liquid developer T in the concentration adjustment tank 27, and a liquid amount upper limit value and liquid amount lower limit value of the liquid developer T in the concentration adjustment tank 27, which are stored in the first RAM 51, are outputted to the concentration/liquid-amount control portion 42.

The concentration/liquid-amount control portion 42 compares the concentration measured by the concentration sensor 39 with the concentration target value from the first RAM 51, compares the liquid amount measured by the liquid amount sensor 40 with a predetermined liquid amount control range established by the liquid amount upper limit value and liquid amount lower limit value from the first RAM 51, and calculates the amount of concentrated toner and the amount of carrier solution to be supplied to the concentration adjustment tank 27 on the basis of the results of these comparisons. The concentration/liquid-amount control portion 42 outputs the calculated supplied amounts to the concentrated toner motor control portion 55 and the carrier solution motor control portion 56. The concentrated toner motor control portion 55 and the carrier solution motor control portion 56 output pulse signals of varying cycles and duty ratios according to the inputted supplied amounts to a concentrated toner pump motor (not shown) and a carrier solution pump motor (not shown), respectively. The operations of the concentrated toner supply pump 34 and the carrier solution supply pump 37 are thereby controlled so that liquid developer T in the concentration adjustment tank 27 reaches a predetermined concentration and a predetermined liquid amount range. Thus, concentration/liquid-amount control of the liquid developer T in the concentration adjustment tank 27 is performed by the concentration/liquid-amount control system 9.

The liquid amount converted by the second calculator 47 from the voltage signal of the liquid amount measured by the liquid amount sensor 50 is differentiated by time by the differentiator 49. Based on a liquid amount time differentiation value from the differentiator 49, the concentrated toner supplied amount and carrier solution supplied amount calculated by the concentration/liquid-amount control portion 42, and the developing portion supply flow rate from the second RAM 52; the flow rate calculating portion 50 calculates a recovered liquid flow rate R0 mL/sec and outputs the flow rate to the comparator 54. The comparator 54 compares the inputted flow rate with a threshold which is a stagnation determination flow rate set in advance and stored in the third RAM 53, and detects whether or not the recovered liquid has stagnated as a result of this comparison. The comparator 54 implements concentration/liquid-amount control by the concentration/liquid-amount control system 9 when recovered liquid stagnation is not detected, and outputs to the concentration/liquid-amount control portion 42 an on/off signal for stopping the concentration/liquid-amount control by the concentration/liquid-amount control system 9 when recovered liquid stagnation is detected. Therefore, the recovered liquid stagnation detection portion is configured by the flow rate calculating portion 50, the third RAM 53, and the comparator 54.

Based on a concentration/liquid-amount control on/off signal inputted from the comparator 54, the concentration/liquid-amount control portion 42 implements or stops concentration/liquid-amount control of the liquid developer T in the concentration adjustment tank 27. This implementing or stopping of concentration/liquid-amount control by the concentration/liquid-amount control system 9 is described in further detail.

During the continuous printing action, when the recovered liquid is moving (flowing) smoothly within the recovered liquid discharge tube 31 without stagnating in the recovered liquid discharge tube 31, although the recovered liquid flow rate R0 mL/sec of the recovered liquid in the recovered liquid discharge tube 31 fluctuates depending on the print data, its value is still within a certain range. When the recovered liquid stagnates within the recovered liquid discharge tube 31, the recovered liquid flow rate R0 mL/sec greatly fluctuates and approaches 0 mL/sec. This recovered liquid flow rate R0 mL/sec can be calculated from the liquid amount fluctuation in the concentration adjustment tank 27 as measured by the liquid amount sensor 40. Specifically, with the liquid amount in the concentration adjustment tank 27 denoted as V mL, the recovered liquid flow rate as R0 mL/sec, the inflow rate of liquid developer flowing into the concentration adjustment tank 27 from a route other than the recovered liquid discharge tube 31 as Sin mL/sec, and the outflow rate of liquid developer flowing out from the concentration adjustment tank 27 as Sout mL/sec; the change over time dV/dt mL/sec in the amount of liquid developer T in the concentration adjustment tank 27 is given by:

dV/dt=R0+Sin−Sout (1)

When this formula (1) is modified for the recovered liquid flow rate R0 mL/sec, the result is:

R0=dV/dt−Sin+Sout (2)

Therefore, using this formula (2), the recovered liquid flow rate R0 mL/sec is calculated from the liquid amount fluctuation in the concentration adjustment tank 27 as measured by the liquid amount sensor 40. In the image formation device 1 of this example, the recovered liquid flow rate R0 mL/sec of the recovered liquid in the recovered liquid discharge tube 31 is calculated by the flow rate calculating portion 50 as previously described, and when the fluctuation of the recovered liquid flow rate R0 mL/sec is greater than a certain range, the comparator 54 distinguishes that stagnation of the recovered liquid has occurred in the recovered liquid discharge tube 31.

A specific example is described of this distinguishing of an occurrence of stagnation. The feed liquid rate S0 mL/sec of the liquid developer T fed from the concentration adjustment tank 27 to the liquid developer storage portion 17 of the developing portion 5 is divided into a draw up liquid rate Saxr mL/sec of the liquid developer T drawn up by the anilox roller 18 and an overflow liquid rate Rof mL/sec of the liquid developer T overflowing out of the liquid developer storage portion 17 into the recovered liquid storage portion 30, as shown in FIG. 2. Therefore, to stably supply the anilox roller 18 with a certain amount of the liquid developer T needed for developing, the feed liquid rate S0 mL/sec to the liquid developer storage portion 17 must be set greater than the optimum value of the draw up liquid rate Saxr mL/sec of the anilox roller 18.

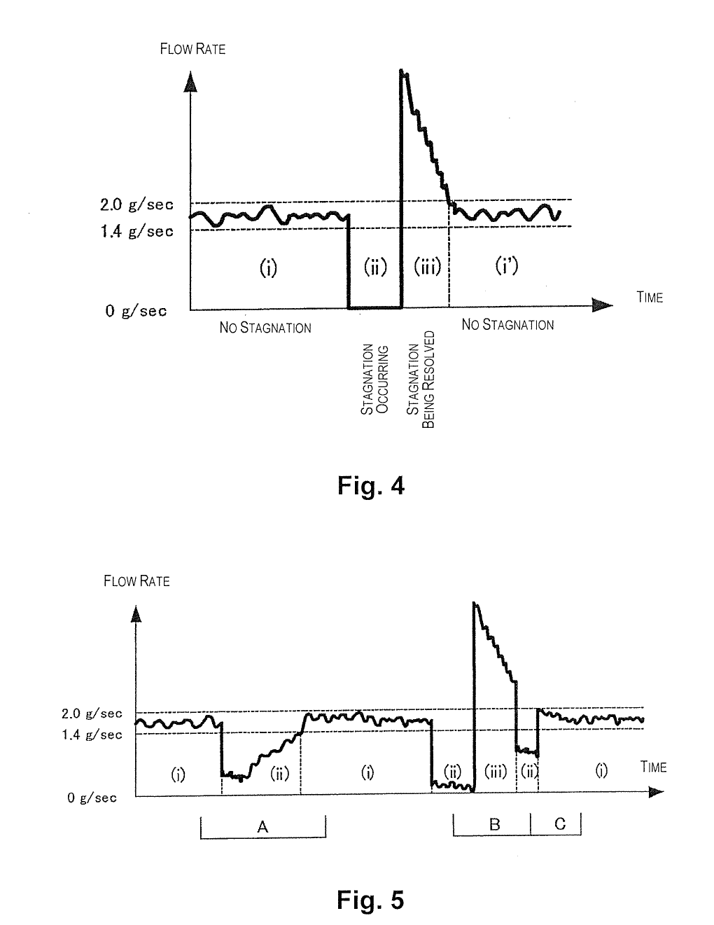

In view of this, this example is designed so that the draw up liquid rate Saxr mL/sec of the anilox roller 18 is 0.6 mL/sec, the feed liquid rate S0 mL/sec to the liquid developer storage portion 17 is 2.0 mL/sec, and the overflow liquid rate Rof mL/sec to the recovered liquid storage portion 30 is 1.4 mL/sec. During the printing action in this example, a recovered liquid rate RCL mL/sec of the liquid developer T per unit time recovered from the intermediate roller 19, the developing roller 20, and the photoreceptor 2, differs depending on the image data being printed, but has a value greater than 0 mL/sec and less than 0.6 mL/sec. In cases in which there is no stagnation of recovered liquid in the recovered liquid discharge tube 31 and the recovered liquid is moving smoothly and continuously from the recovered liquid storage portion 30 to the concentration adjustment tank 27, the recovered liquid flow rate R0 mL/sec is equal to the sum of the overflow liquid rate Rof mL/sec and the recovered liquid rate RCL mL/sec (R0=Rof+RCL), as shown in FIG. 4. Therefore, the recovered liquid flow rate R0 mL/sec has a value greater than 1.4 mL/sec and less than 2.0 mL/sec (1.4 mL/sec to 2.0 mL/sec), shown in FIG. 4 by (i).

When stagnation of the recovered liquid occurs in the recovered liquid discharge tube 31, the recovered liquid flow rate R0 mL/sec of the recovered liquid changes significantly. Specifically, the recovered liquid flow rate R0 mL/sec has a value of 0 mL/sec, or less than (Rof+RCL) mL/sec, shown in FIG. 4 by (ii). When the recovered liquid stagnation is being resolved with a comparatively high speed, the recovered liquid flow rate R0 mL/sec increases significantly as shown by (iii) in FIG. 4 because the stagnant recovered liquid flows into the concentration adjustment tank 27 in a short amount of time. When all of the stagnant recovered liquid has finished flowing into the concentration adjustment tank 27, the discharge liquid rate R0 mL/sec again reaches a value in a range of 1.4 mL/sec to 2.0 mL/sec as shown by (i′) in FIG. 4, similar to (i).

In view of this, the image formation device 1 of this example divides the recovered liquid discharge state into the following three states depending on whether or not there is stagnation of the recovered liquid, and determines which of these recovered liquid discharge states is in effect according to the value of the recovered liquid flow rate R0 mL/sec. Specifically:
(i) No stagnation (1.4 mL/sec<R0 mL/sec<2.0 mL/sec)
(ii) Stagnation (Ro mL/sec<1.4 mL/sec)
(iii) Stagnation being resolved (Ro mL/sec≧2.0 mL/sec)

The actual flow of recovered liquid within the recovered liquid discharge tube 31 does not necessarily change in the order (i)→(ii)→(iii)→(i′) as shown in FIG. 4, but also changes in various ways such as is shown in FIG. 5, for example. Specifically, after stagnation of the recovered liquid has occurred as shown by A in FIG. 5 and the recovered liquid flow rate R0 mL/sec has changed to a low value shown by (ii) in FIG. 5, for example, the stagnation is resolved gradually during stagnation resolving, whereby the recovered liquid flow rate R0 mL/sec increases gradually. However, there are cases in which the recovered liquid flow rate R0 mL/sec changes so as to return to the state of no stagnation shown by (i) in FIG. 5 (the same state as is shown by (i′) in FIG. 4) without increasing significantly as shown by (iii) in FIG. 4 (i.e. without undergoing (iii) shown in FIG. 4).

After stagnation of the recovered liquid has occurred as shown by B in FIG. 5 and the recovered liquid flow rate R0 mL/sec has changed to a low value shown by (ii) in FIG. 5, the stagnation is resolved at a relatively high speed during stagnation resolving, whereby the recovered liquid flow rate R0 mL/sec increases significantly. In some cases, when stagnation occurs again during this stagnation resolving (a state that does not reach “no stagnation”), the discharge liquid rate R0 mL/sec changes to a value equal to or less than 1.4 mL/sec, i.e. changes as shown by (iii) (ii) in FIG. 5.

Furthermore, after stagnation of the recovered liquid has occurred as shown by C in FIG. 5 and the recovered liquid flow rate R0 mL/sec has changed to a low value shown by (ii) in FIG. 5, when the stagnation time duration is comparatively short and the stagnation amount is small, there are cases in which the recovered liquid flow rate R0 mL/sec changes to a state of no stagnation, i.e. changes as shown by (ii)→(i) in FIG. 5, similar to the previously described case in which the recovered liquid flow rate R0 mL/sec returns to the state of no stagnation shown by (i) in FIG. 5 without undergoing (iii) shown in FIG. 4. The actual flow of the recovered liquid within the recovered liquid discharge tube 31 sometimes changes in other various ways as well. In such cases, regardless of how the actual flow of recovered liquid changes, it is possible to determine the state of recovered liquid stagnation at the time of liquid amount measurement (i.e. currently occurring) by using formula (2) to calculate the recovered liquid flow rate R0 mL/sec of the recovered liquid discharge tube 31 on the basis of the fluctuation in the amount of the liquid developer T in the concentration adjustment tank 27 as measured by the liquid amount sensor 40 as previously described.

Specifically, in the image formation device 1 of this example, the outflow rate Sout mL/sec of the liquid developer T from the concentration adjustment tank 27 is first merely the feed liquid rate S0 mL/sec of the liquid developer to the developing portion 5. Therefore:

Sout=So (3)

The inflow rate Sin mL/sec of the liquid developer T from other routes to the concentration adjustment tank 27 is a combination of the feed toner rate Sto mL/sec of the concentrated toner T1 from the concentrated toner supply tank 33 and the feed solution rate Sca mL/sec of the carrier solution T2 from the carrier solution supply tank 36. Therefore:

Sin=Sto+Sca (4)

Substituting the feed toner rate Sto mL/sec and the feed solution rate Sca mL/sec in formula (2) results in:

Ro=dV/dt+S0−Sto−Sca (5)

The feed liquid rate S0 mL/sec of the liquid developer T to the developing portion 5 is a constant value of 2.0 mL/sec, and the feed toner rate Sto mL/sec of the concentrated toner T1 and the feed solution rate Sca mL/sec of the carrier solution T2 are both values established by the concentration/liquid-amount control portion 42. The change over time (dV/dt) in the liquid amount of the liquid developer T in the concentration adjustment tank 27 is determined according to the liquid amount measured by the liquid amount sensor 40. Therefore, the recovered liquid flow rate R0 mL/sec is determined by substituting these values in formula (5). The state of stagnation of the recovered liquid in the recovered liquid discharge tube 31 is determined based on the recovered liquid flow rate R0 mL/sec thus determined.

Next, the action of the concentration/liquid-amount control system 9 during an occurrence of recovered liquid stagnation will be described. During states of no stagnation shown by (i) (including the state of (i′) shown in FIG. 4) and states of stagnation being resolved shown by (iii), the concentration/liquid-amount control system 9 simultaneously performs concentration adjustment and liquid amount control of the liquid developer T in the concentration adjustment tank 27, so that the concentration of the liquid developer T in the concentration adjustment tank 27 reaches a concentration target value and the amount of the liquid developer T in the concentration adjustment tank 27 reaches a predetermined liquid amount control range between the preset liquid amount upper limit value and liquid amount lower limit value.

During a state of stagnation shown by (ii), when concentration adjustment and liquid amount control of the liquid developer T is performed by the concentration/liquid-amount control system 9 in the same manner as during the previously described states shown by (i) and (iii), there is a possibility that the liquid developer T in the concentration adjustment tank 27 will overflow during stagnation resolution. Since only a small amount of recovered liquid is returned into the concentration adjustment tank 27 during a stagnation occurrence, the concentration in the concentration adjustment tank 27 is unlikely to fluctuate. In view of this, during a state of stagnation shown by (ii), the concentration/liquid-amount control system 9 stops concentration adjustment and liquid amount control of the liquid developer T and does not replenish concentrated toner or carrier solution to the concentration adjustment tank 27. Furthermore, when the recovered liquid stagnation is resolved and the discharge state of recovered liquid is the state shown by (ii) or (iii), the concentration/liquid-amount control system 9 restarts the previously described concentration adjustment and liquid amount control.

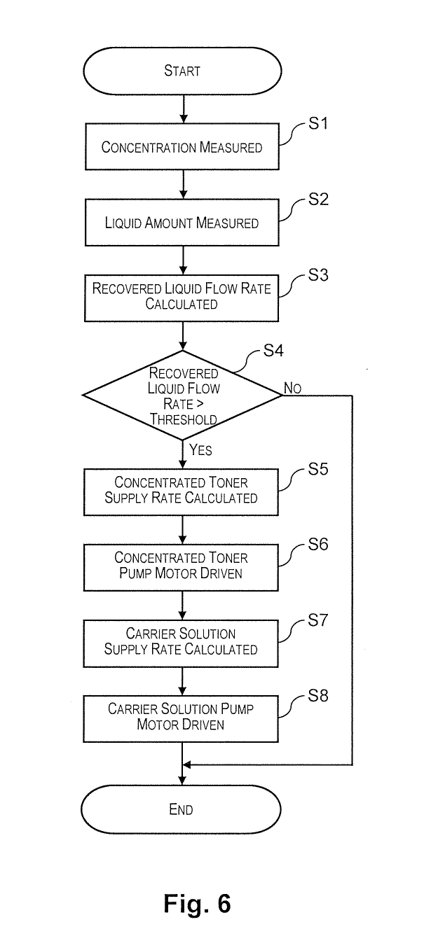

FIG. 6 is a chart showing the flow of concentration adjustment and liquid amount control by the concentration/liquid-amount control system. During concentration adjustment and liquid amount control as shown in FIG. 6, first, in step S1, the concentration of the liquid developer T in the concentration adjustment tank 27 is measured by the concentration sensor 39, and in step S2, the amount of the liquid developer T in the concentration adjustment tank 27 is measured by the liquid amount sensor 40. Furthermore, in step S3, the flow rate R0 mL/sec of recovered liquid moving through the recovered liquid discharge tube 31 is calculated in the manner previously described. Next, in step S4, a determination is made as to whether or not the recovered liquid flow rate R0 mL/sec is greater than a preset threshold. In other words, a distinction is made as to whether or not stagnation of the liquid developer has occurred in the recovered liquid discharge tube 31. This threshold can be set, for example, to the 1.4 mL/sec at which a state of stagnation is determined as shown by (ii) of the previous example.

When the recovered liquid flow rate R0 mL/sec of the recovered liquid is determined to be greater than the threshold (flow rate>threshold), i.e. when a distinction is made that the liquid developer is not stagnating, the concentration/liquid-amount control portion 42 calculates the concentrated toner supply rate on the basis of the measured concentration and liquid amount in step S5, and the concentrated toner motor control portion 55 outputs a pulse signal and drives a concentrated toner pump motor (not shown) on the basis of the calculated concentrated toner supply rate in step S6. The concentration/liquid-amount control portion 42 calculates the carrier solution supply rate on the basis of the measured concentration and liquid amount in step S7, and the carrier solution motor control portion 56 outputs a pulse signal and drives a carrier solution pump motor (not shown) on the basis of the calculated carrier solution supply rate in step S8. The concentrated toner supply pump 34 and the carrier solution supply pump 37 are thereby operated, concentration adjustment and liquid amount control are performed by the concentration/liquid-amount control system 9, and the liquid developer T in the concentration adjustment tank 27 is adjusted to a predetermined first toner concentration and controlled to a liquid amount in a predetermined range. When the concentration of the liquid developer T is thereafter adjusted to a predetermined concentration and the amount of liquid developer T is controlled to a liquid amount in a predetermined range, the concentrated toner supply pump 34 and the carrier solution supply pump 37 are stopped, and concentration adjustment and liquid amount control by the concentration/liquid-amount control system 9 are ended.

In step S4, when the recovered liquid flow rate R0 mL/sec of the recovered liquid is determined to be not greater than the threshold (flow rate≦threshold), i.e. when a distinction is made that the liquid developer is stagnating, the process in steps S5 through S8 are bypassed and not performed, and the action of the concentration/liquid-amount control system 9 ends. Specifically, in this case, the recovered liquid is determined to be stagnating as shown by (ii), and concentration adjustment and liquid amount control by the concentration/liquid-amount control system 9 are stopped (not performed).

According to the image formation device 1 of this example, the flow rate R0 mL/sec of recovered liquid moving through the recovered liquid discharge tube 31 is calculated based on the amount of liquid developer T stored in the liquid amount adjustment tank 27 as measured by the liquid amount sensor 40. When the calculated recovered liquid flow rate R0 mL/sec is greater than the preset threshold, the recovered liquid continues to move smoothly through the recovered liquid discharge tube 31, and a distinction is made that the recovered liquid is not stagnating in the recovered liquid discharge tube 31. Therefore, at this time, the concentration of the liquid developer T in the concentration adjustment tank 27 is adjusted and the amount of the liquid developer in the liquid developer concentration adjustment portion is controlled according to the concentration of the liquid developer T in the concentration adjustment tank 27 as measured by the concentration sensor 39 and the amount of the liquid developer T in the concentration adjustment tank 27 as measured by the liquid amount sensor 40. Due to this liquid developer concentration adjustment and liquid developer amount control, the concentrated toner T1 of the concentrated toner supply tank 33 and the carrier solution T2 of the concentrated toner supply tank 33 are supplied to the concentration adjustment tank 27. When the recovered liquid flow rate R0 mL/sec calculated as previously described is equal to or less than the aforementioned threshold, the movement of recovered liquid through the recovered liquid discharge tube 31 stagnates, and a distinction is therefore made that the recovered liquid is stagnating in the recovered liquid discharge tube 31. Therefore, the concentration adjustment of the liquid developer T in the concentration adjustment tank 27 and the liquid amount control of the liquid developer T in the concentration adjustment tank 27 are stopped at this time. Thereby, the concentrated toner T1 of the concentrated toner supply tank 33 and the carrier solution T2 of the concentrated toner supply tank 33 are not supplied to the concentration adjustment tank 27 even if there is a small amount of liquid developer T in the concentration adjustment tank 27.

Thus, when recovered liquid stagnation has occurred in the recovered liquid discharge tube 31, concentration adjustment of the liquid developer T stored in the concentration adjustment tank 27 and liquid amount control of the liquid developer T of the concentration adjustment tank 27 are not performed. Therefore, even if the concentration or amount of liquid developer T of the concentration adjustment tank 27 significantly changes due to recovered liquid stagnation, new concentrated toner T1 and new carrier solution T2 are not supplied to the concentration adjustment tank 27. Thereby, the level of liquid developer T in the concentration adjustment tank 27 does not rise. When the recovered liquid stagnating in the recovered liquid discharge tube 31 falls to the concentration adjustment tank 27 due to its own weight in this state and the recovered liquid stagnation is resolved, the recovered liquid that had been stagnant flows into the concentration adjustment tank 27 in a short amount of time, and the liquid level in the concentration adjustment tank 27 therefore rises. However, since the liquid level in the concentration adjustment tank 27 does not rise due to new concentrated toner T1 and new carrier solution T2 not being supplied, the liquid level in the concentration adjustment tank 27 does not rise significantly even if the liquid level in the concentration adjustment tank 27 is so raised by the recovered liquid. The liquid developer T in the concentration adjustment tank 27 can thereby be prevented from overflowing. Since overflowing of the liquid developer T is prevented, there is a greater degree of freedom in supplying the concentrated toner T1 as well as supplying the carrier solution T2, and the concentration of the liquid developer T can therefore be easily and reliably adjusted.

Therefore, even if highly viscous liquid developer is used, a continuous printing action can be performed while the concentration of the liquid developer T in the concentration adjustment tank 27 is maintained at a predetermined concentration and the amount of liquid developer T in the concentration adjustment tank 27 is maintained within a predetermined range. Continuous printing with high image quality can thereby be stably performed without interrupting the continuous printing action.

Particularly, the recovered liquid flow rate in the recovered liquid discharge tube 31 is calculated based on the amount of liquid developer T in the concentration adjustment tank 27 by the liquid amount sensor 40, and the calculated recovered liquid flow rate is used to distinguish stagnation of the recovered liquid occurring in the recovered liquid discharge tube 31. Therefore, a special flow rate sensor or the like for measuring the recovered liquid flow rate need not be used. Thereby, there is little need to change the design of a well-known concentration/liquid-amount control system 9, and stagnation of the recovered liquid occurring in the recovered liquid discharge tube 31 can be detected more reliably with a simple configuration.

The image formation method and image formation device of the invention are not limited to the examples of the embodiment previously described, and various design modifications can be made within the range of the scope laid out in the patent claims.

What is claimed is:

1. An image formation device comprising:
a latent image carrier on which a latent image is formed;
a developing portion having a liquid developer storage portion for storing liquid developer including a toner and a carrier solution, a developer carrier for developing the latent image formed on the latent image carrier using the liquid developer, and a developer carrier cleaning member for cleaning the developer carrier on which the latent image is developed;
a liquid developer concentration adjustment portion which has a concentration measurement portion for measuring the toner concentration of the stored liquid developer, and a liquid amount measurement portion for measuring the amount of liquid developer;
and which adjusts to a first toner concentration the toner concentration of liquid developer supplied to the liquid developer storage portion of the developing portion and controls the amount of the liquid developer;
a liquid developer supply portion for supplying the liquid developer storage portion with liquid developer of a first toner concentration adjusted by the liquid developer concentration adjustment portion;
a toner supply portion for supplying the liquid developer concentration adjustment portion with liquid developer of a second toner concentration which is a higher toner concentration than the first toner concentration;
a carrier solution supply portion for supplying a carrier solution to the liquid developer concentration adjustment portion;
a recovered liquid storage portion for storing the liquid developer recovered by the developer carrier cleaning member;
a control portion for controlling the amount of liquid developer supplied form the toner supply portion and the amount of carrier solution supplied from the carrier solution supply portion on the basis of the toner concentration of the liquid developer measured by the concentration measurement portion and the amount of liquid developer measured by the liquid amount measurement portion to adjust the toner concentration of the liquid developer in the liquid developer concentration adjustment portion and control the amount of the liquid developer in the liquid developer concentration adjustment portion;
a recovery route for moving the liquid developer stored in the recovered liquid storage portion to the liquid developer concentration adjustment portion; and
a recovered liquid stagnation detection portion for detecting stagnation of the liquid developer moving through the recovery route on the basis of the amount of liquid developer of the liquid developer concentration adjustment portion measured by the liquid amount measurement portion,
the control portion adjusting the toner concentration of the liquid developer in the liquid developer concentration adjustment portion and controlling the amount of liquid developer of the liquid developer concentration adjustment portion when the recovered liquid stagnation detection portion does not detect the stagnation of the recovered liquid.

2. The image formation device according to claim 1, wherein
the control portion stops the adjustment of the toner concentration of the liquid developer in the liquid developer concentration adjustment portion and stops the control of the amount of the liquid developer in the liquid developer concentration adjustment portion when the recovered liquid stagnation detection portion has detected stagnation of the liquid developer moving through the recovery route.

3. The image formation device according to claim 2, wherein
the recovered liquid stagnation detection portion includes:
a flow rate calculation portion for calculating the flow rate of liquid developer moving through the recovery route on the basis of the amount of the liquid developer in the liquid developer concentration adjustment portion measured by the liquid amount measurement portion; and
a comparator for comparing the flow rate of the liquid developer calculated by the flow rate calculation portion and a preset threshold;
wherein the comparator distinguishes that the stagnation of the liquid developer has not occurred when the liquid developer flow rate calculated by the flow rate calculation portion is greater than the threshold, and distinguishes that the stagnation of the liquid developer has occurred when the recovered liquid flow rate calculated by the flow rate calculation portion is equal to or less than the threshold.

4. The image formation device according to claim 1, further comprising
a dividing portion which divides the recovered liquid storage portion and the liquid developer storage portion, and which has a flow portion for allowing the liquid developer stored in the liquid developer storage portion to flow from the liquid developer storage portion to the recovered liquid storage portion.

5. The image formation device according to claim 4, wherein
the developing portion includes
a liquid developer supply member for carrying the liquid developer in the liquid developer storage portion and supplying the carried liquid developer to the developer carrier; and
a liquid developer supply member cleaning member for cleaning the liquid developer supply member which has supplied the liquid developer to the developer carrier.

6. An image formation method comprising:
a latent image is developed using a developer carrier which carries a liquid developer including a toner and a carrier solution;
the developer carrier on which the latent image has been developed is cleaned and the liquid developer is recovered;
the recovered liquid developer is moved through a recovery route and stored in a liquid developer concentration adjustment portion;
the amount of liquid developer stored in the liquid developer concentration adjustment portion is measured;
a convection flow of the liquid developer moving through the recovery route is distinguished based on the measured amount of liquid developer; and
when the liquid developer in the recovery route is distinguished as not being stagnant, the toner concentration of the liquid developer in the liquid developer concentration adjustment portion is adjusted and the amount of the liquid developer in the liquid developer concentration adjustment portion is controlled.

7. The image formation method according to claim 6, wherein
the adjustment of the toner concentration of the liquid developer in the liquid developer concentration adjustment portion is stopped when the liquid developer is distinguished as being stagnant.
